(19) United States
(12) Patent Application Publication
(10) Pub. No.: US 2020/0258450 A1
(43) Pub. Date: Aug. 13, 2020

(54) DISPLAY PANEL AND DISPLAY APPARATUS

(71) Applicant: Truly (Huizhou) Smart Display Limited, Guangdong (CN)

(72) Inventors: Zhongyi HU, Guangdong (CN); Jinkun WU, Guangdong (CN); Junwen HU, Guangdong (CN); Junhai SU, Guangdong (CN); Jianhua LI, Guangdong (CN)

(21) Appl. No.: 16/648,236

(22) PCT Filed: Jun. 1, 2018
(86) PCT No.: PCT/CN2018/089558

§ 371 Date: Mar. 18, 2020

(30) Foreign Application Priority Data
Sep. 21, 2017 (CN) 201710859550.2

(51) Int. Cl. G09G 3/3233

(52) U.S. Cl. CPC G09G 3/3233; G09G 2310/061

(57) ABSTRACT

The present invention relates to a display panel and a display apparatus, the display panel comprising: a plurality of pixel circuits and a plurality of voltage compensation circuits; the voltage compensation circuits comprise an initialising circuit, a short connection circuit, a programming voltage input circuit, and a programming current output circuit; the initialising circuit comprises a first capacitor, a first end of the first capacitor being used for connecting to a first voltage signal end; the programming current output circuit comprises a first drive transistor, a control end of the first drive transistor being connected to the first end of the first capacitor, the control end of the first drive transistor being connected to a first connecting end by means of the short connection circuit, a second connecting end of the first drive transistor being connected to the programming voltage input circuit and a programming current output end; and the programming current output end is respectively connected to the plurality of pixel circuits. The display area uses pixel circuits of a current compensation mode, such that the circuit structure is simple and the area of the pixel circuits is smaller, and the electron mobility of the second drive transistor of the display area can also be compensated.

### CROSS REFERENCE TO RELATED APPLICATION

This application claims priority to Chinese Patent Application No. 2017108595502, filed with the China National Intellectual Property Administration on Sep. 21, 2017, and entitled “DISPLAY PANEL AND DISPLAY APPARATUS”, which is incorporated herein by reference in its entirety.

### BACKGROUND OF THE INVENTION

The present invention relates to the field of light-emitting display technologies, and in particular, to a display panel and a display apparatus.

To resolve a problem of spatial heterogeneity of a TFT (Thin Film Transistor, thin film transistor) in an OLED (Organic Light-Emitting Diode, organic light-emitting diode) panel in an existing process, most of existing pixel circuits compensate Vth (threshold voltage) of the TFT through voltage programming, thereby resolving a Vth heterogeneity problem of each DTFT (a TFT that provides a drive current) in a space, so that currents flowing through OLEDs in the space are consistent. However, in addition to Vth heterogeneity, electron mobility p can also affect the drive current of the DTFT, electron mobility p in different spaces and at different times may also be heterogeneous, and electron mobility p cannot be compensated for through voltage programming.

In order to resolve the foregoing problems, current compensation can be performed through current programming. However, in a conventional display apparatus, there is no suitable drive IC (integrated circuit, integrated circuit) dedicatedly used for current programming. Consequently, it is relatively difficult to achieve a current compensation effect and the effect is relatively poor.

### BRIEF SUMMARY OF THE INVENTION

Based on the embodiments of this application, a display panel and a display apparatus are provided.

A display panel is provided, including a plurality of pixel circuits and a plurality of voltage compensation circuits;

each of the voltage compensation circuits includes an initialization circuit, a short-connection circuit, a programming voltage input circuit, and a programming current output circuit;

the initialization circuit includes a first capacitor, a first end of the first capacitor is connected to a first voltage signal end, and a second end of the first capacitor is connected to a second voltage signal end;

the programming current output circuit includes a first driving transistor, a control end of the first driving transistor is connected to the first end of the first capacitor, the control end of the first driving transistor is connected to a first connection end of the first driving transistor by using a short-connection circuit, and a second connection end of the first driving transistor is connected to the programming voltage input circuit;

the programming voltage input circuit is connected to a programming voltage input end, the first connection end of the first driving transistor is further connected to a third voltage signal end, and the second connection end of the first driving transistor is further connected to a programming current output end; and

the programming current output end is separately connected to the plurality of pixel circuits.

In an embodiment, the initialization circuit further includes a first transistor and a seventh transistor, a first connection end of the first transistor is connected to the first voltage signal end, a second connection end of the first transistor is connected to the first end of the first capacitor, the second end of the first capacitor is connected to a first connection end of the seventh transistor, and a second connection end of the seventh transistor is connected to the second voltage signal end; and

a control end of the first transistor is connected to a first control signal end, and a control end of the seventh transistor is connected to a second control signal end.

In an embodiment, the short-connection circuit includes a second transistor, a first connection end of the second transistor is connected to the control end of the first driving transistor, a second connection end of the second transistor is connected to the first connection end of the first driving transistor, and a control end of the second transistor is connected to a third control signal end.

In an embodiment, the programming voltage input circuit includes a third transistor, a first connection end of the third transistor is connected to the second connection end of the first driving transistor, a second connection end of the third transistor is connected to the programming voltage input end, and a control end of the third transistor is connected to a third control signal end.

In an embodiment, the programming current output circuit further includes a fourth transistor, a fifth transistor, and a sixth transistor;

a first connection end of the sixth transistor is connected to the third voltage signal end, a second connection end of the sixth transistor is connected to the first connection end of the first driving transistor, the second connection end of the first driving transistor is connected to a first connection end of the fifth transistor, a second connection end of the fifth transistor is connected to a first connection end of the fourth transistor, a second connection end of the fourth transistor is connected to the programming current output end, and the programming current output end is separately connected to the pixel circuits; and

a control end of the fourth transistor, a control end of the fifth transistor, and a control end of the sixth transistor are separately connected to a fourth control signal end,

In an embodiment, each of the voltage compensation circuits is disposed in two rows.

In an embodiment, each of the pixel circuits is disposed in a plurality of rows, and pixel circuits in a same row are separately connected to programming current output ends of voltage compensation circuits in a same row.

In an embodiment, pixel circuits in two adjacent rows are respectively connected to programming current output ends of voltage compensation circuits in divergent rows.

In an embodiment, pixel circuits in an odd-numbered row are connected to programming current output ends of voltage compensation circuits in one row, and pixel circuits in an even-numbered row are connected to programming current output ends of voltage compensation circuits in the other row.

In an embodiment, each of the pixel circuits includes a first switching transistor, a second switching transistor, a third switching transistor, a fourth switching transistor, a second capacitor, a second driving transistor, and an electroluminescent device;

a first connection end of the first switching transistor is connected to the first voltage signal end, a second connection end of the first switching transistor is separately connected to a first end of the second capacitor and a control end of the second driving transistor, a second end of the second capacitor is connected to a second connection end of the second driving transistor, the second connection end of the second driving transistor is connected to the second voltage signal end, a first connection end of the second driving transistor is separately connected to a first connection end of the third switching transistor, a first connection end of the second switching transistor, and a first connection end of the fourth switching transistor, a second connection end of the third switching transistor is connected to the programming current output end, a second connection end of the second switching transistor is connected to the first end of the second capacitor, a second connection end of the fourth switching transistor is connected to a positive electrode of the electroluminescent device, and a negative electrode of the electroluminescent device is connected to the third voltage signal end; and

a control end of the first switching transistor s connected to a fifth control signal end, a control end of the second switching transistor and a control end of the third switching transistor are connected to a sixth control signal end, and a control end of the fourth switching transistor is connected to a seventh control signal end.

A display apparatus is provided, including a display panel, where the display panel includes a plurality of pixel circuits and a plurality of voltage compensation circuits;

each of the voltage compensation circuits includes an initialization circuit, a short-connection circuit, a programming voltage input circuit, and a programming current output circuit;

the initialization circuit includes a first capacitor, a first end of the first capacitor s connected to a first voltage signal end, and a second end of the first capacitor is connected to a second voltage signal end;

the programming current output circuit includes a first driving transistor, a control end of the first driving transistor is connected to the first end of the first capacitor, the control end of the first driving transistor is connected to a first connection end of the first driving transistor by using a short-connection circuit, and a second connection end of the first driving transistor is connected to the programming voltage input circuit;

the programming voltage input circuit is connected to a programming voltage input end, the first connection end of the first driving transistor is further connected to a third voltage signal end, and the second connection end of the first driving transistor is further connected to a programming current output end; and

the programming current output end is separately connected to the plurality of pixel circuits,

In an embodiment, the initialization circuit further includes a first transistor and a seventh transistor, a first connection end of the first transistor is connected to the first voltage signal end, a second connection end of the first transistor is connected to the first end of the first capacitor, the second end of the first capacitor is connected to a first connection end of the seventh transistor, and a second connection end of the seventh transistor is connected to the second voltage signal end; and

a control end of the first transistor is connected to a first control signal end, and a control end of the seventh transistor is connected to a second control signal end.

In an embodiment, the short-connection circuit includes a second transistor, a first connection end of the second transistor s connected to the control end of the first driving transistor, a second connection end of the second transistor is connected to the first connection end of the first driving transistor, and a control end of the second transistor is connected to a third control signal end.

In an embodiment, the programming voltage input circuit includes a third transistor, a first connection end of the third transistor is connected to the second connection end of the first driving transistor, a second connection end of the third transistor is connected to the programming voltage input end, and a control end of the third transistor is connected to a third control signal end.

In an embodiment, the programming current output circuit further includes a fourth transistor, a fifth transistor, and a sixth transistor;

a first connection end of the sixth transistor is connected to the third voltage signal end, a second connection end of the sixth transistor is connected to the first connection end of the first driving transistor, the second connection end of the first driving transistor is connected to a first connection end of the fifth transistor, a second connection end of the fifth transistor is connected to a first connection end of the fourth transistor, a second connection end of the fourth transistor is connected to the programming current output end, and the programming current output end is separately connected to the pixel circuits; and

a control end of the fourth transistor, a control end of the fifth transistor, and a control end of the sixth transistor are separately connected to a fourth control signal end.

In an embodiment, each of the voltage compensation circuits is disposed in two rows.

In an embodiment, each of the pixel circuits is disposed in a plurality of rows, and pixel circuits in a same row are respectively connected to programming current output ends of voltage compensation circuits in a same row.

In an embodiment, pixel circuits in two adjacent rows are respectively connected to programming current output ends of voltage compensation circuits in divergent rows.

in an embodiment, pixel circuits in an odd-numbered row are connected to programming current output ends of voltage compensation circuits in one row, and pixel circuits in an even-numbered row are connected to programming current output ends of voltage compensation circuits in the other row.

In an embodiment, each of the pixel circuits includes a first switching transistor, a second switching transistor, a third switching transistor, a fourth switching transistor, a second capacitor, a second driving transistor, and an electroluminescent device;

a first connection end of the first switching transistor is connected to the first voltage signal end, a second connection end of the first switching transistor is separately connected to a first end of the second capacitor and a control end of the second driving transistor, a second end of the second capacitor is connected to a second connection end of the second driving transistor, the second connection end of the second driving transistor is connected to the second voltage signal end, a first connection end of the second driving transistor is separately connected to a first connection end of the third switching transistor, a first connection end of the second switching transistor, and a first connection end of the fourth switching transistor, a second connection end of the third switching transistor is connected to the programming current output end, a second connection end of the second switching transistor is connected to the first end of he second capacitor, a second connection end of the fourth switching transistor s connected to a positive electrode of the electroluminescent device, and a negative electrode of the electroluminescent device is connected to the third voltage signal end; and

a control end of the first switching transistor is connected to a fifth control signal end, a control end of the second switching transistor and a control end of the third switching transistor are connected to a sixth control signal end, and a control end of the fourth switching transistor is connected to a seventh control signal end.

Details of one or more embodiments of the present invention are provided in the following accompanying drawings and descriptions. Other features, objectives, and advantages of the present invention become apparent in the specification, the accompanying drawings, and the claims.

### BRIEF DESCRIPTION OF THE DRAWINGS

To better describe and illustrate embodiments and/or examples of those inventions disclosed herein, reference may be made to one or more accompanying drawings. Additional details or examples used to describe the accompanying drawings should not be considered as limiting the scope of any of the disclosed inventions, the currently described embodiments and/or examples, and a currently understood best mode of these inventions.

FIG. 1 is a schematic diagram of a circuit principle of a display apparatus according to an embodiment;

FIG. 2 is a schematic diagram of a circuit principle of a voltage compensation circuit according to an embodiment;

FIG. 3 is a schematic diagram of a circuit principle of a voltage compensation circuit according to another embodiment;

FIG. 4 is a diagram of a control signal sequence of a voltage compensation circuit according to an embodiment;

FIG. 5 is a schematic diagram of a circuit principle of a pixel circuit according to an embodiment;

FIG. 6 is a diagram of a control signal sequence of a pixel circuit according to an embodiment; and

FIG. 7 is a diagram of control signal sequences of a pixel circuit and a voltage compensation circuit according to an embodiment.

### DETAILED DESCRIPTION OF THE INVENTION

To facilitate understanding of the present invention, the present invention is more comprehensively described below with reference to the related accompanying drawings. Preferred embodiments of the present invention are provided in the accompanying drawings. However, the present invention can be implemented in many different forms, and is not limited to the embodiments described in the specification, In contrast, an objective of providing these embodiments is to provide a more thorough and comprehensive understanding of disclosed content of the present invention.

It is to be noted that when one element is referred to as being “fastened” to another element, the element may be directly on the another element or an intervening element may be present. When one element is considered as being “connected” to another element, the element may be directly connected to the another element or an intervening element may be present simultaneously.

Unless otherwise defined, all technical and scientific terms used in the specification are the same as meanings that are commonly understood by a person of ordinary skill in the art and that belong to the present invention. The terms used in the specification of the present invention are only for the purpose of describing specific embodiments, and are not intended to limit the present invention.

For example, a display panel is provided, including a plurality of pixel circuits and a plurality of voltage compensation circuits. Each of the voltage compensation circuits includes an initialization circuit, a short-connection circuit, a programming voltage input circuit, and a programming current output circuit. The initialization circuit includes a first capacitor, and a first end of the first capacitor is connected to a first voltage signal end, and a second end of the first capacitor is connected to a second voltage signal end. The programming current output circuit includes a first driving transistor, a control end of the first driving transistor is connected to the first end of the first capacitor, the control end of the first driving transistor is connected to a first connection end of the first driving transistor by using the short-connection circuit, and a second connection end of the first driving transistor is connected to the programming voltage input circuit. The programming voltage input circuit is connected to a programming voltage input end, the first connection end of the first driving transistor is further connected to a third voltage signal end, and the second connection end of the first driving transistor is further connected to a programming current output end. The programming current output end is separately connected to the plurality of pixel circuits.

In the foregoing embodiment, in a first sequence, the initialization circuit is turned on, and voltages at two ends of the first capacitor are initialized. Then in a second sequence, a short connection is established between the control end and the first connection end of the first driving transistor by using the short-connection circuit, and the programming voltage input end inputs a voltage to the first driving transistor, so that the voltage that is input by the programming voltage input end to the first driving transistor is compensated for. In a third sequence, the programming current output end of the programming current output circuit provides the pixel circuit with a current that is compensated for, so that the current of the pixel circuit is compensated for with a relatively desirable current compensation effect. In addition, no dedicated current programming IC is required, thereby effectively reducing current compensation difficulty and production costs, In addition, because a current compensation pixel circuit is used in a view area, a circuit structure is relatively simple, and a second driving transistor has a relatively small length, thereby contributing to make a smaller area of the pixel circuit and easier implementation of a high PPI (Pixels Per Inch, pixels per inch). In addition, electron mobility of the second driving transistor in the view area can be further compensated for.

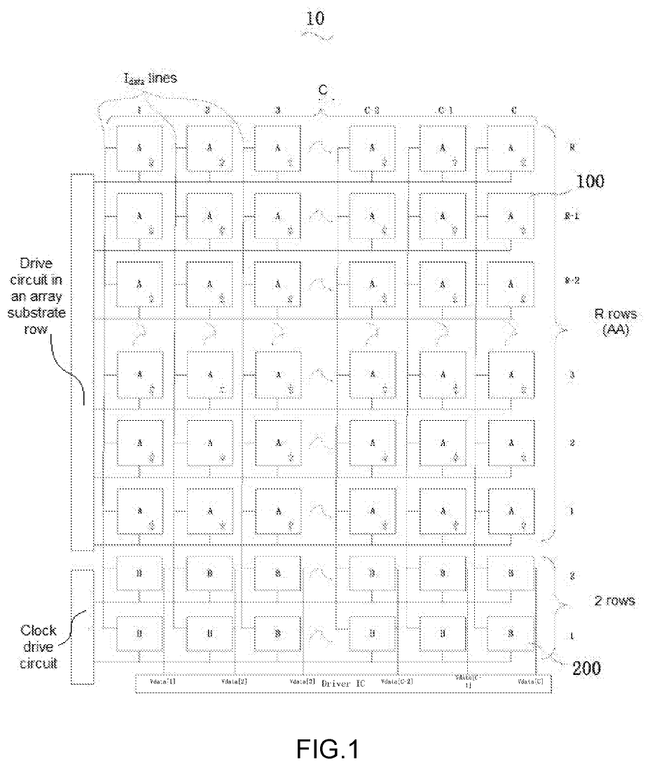

In an embodiment, a display panel 10 is provided, as shown in FIG. 1, including a plurality of pixel circuits 100 and a plurality of voltage compensation circuits 200.

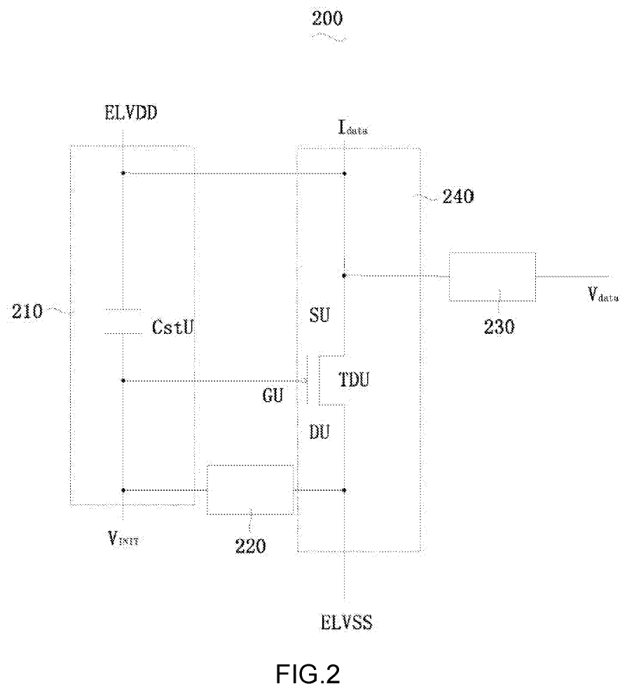

As shown in FIG. 2, each of the voltage compensation circuits 200 includes an initialization circuit 210, a short-connection circuit 220, a programming voltage input circuit 230, and a programming current output circuit 240. The initialization circuit 210 includes a first capacitor CstU, a first end of the first capacitor CstU is connected to a first voltage signal end, and a second end of the first capacitor CstU is connected to a second voltage signal end. The programming current output circuit 240 includes a first driving transistor TDU, a control end of the first driving transistor TDU is connected to the first end of the first capacitor CstU, the control end of the first driving transistor TDU is connected to a first connection end of the first driving transistor TDU by using the short-connection circuit 220, and a second connection end of the first driving transistor TDU is connected to the programming voltage input circuit 230. The programming voltage input circuit 230 is connected to a programming voltage input end, the first connection end of the first driving transistor TDU is further connected to a third voltage signal end, and the second connection end of the first driving transistor TDU is further connected to a programming current output end. The programming current output end is separately connected to the plurality of pixel circuits 100.

Specifically, the display panel 10 includes the pixel circuits 100, and each of the pixel circuits 100 includes one electroluminescent device. For example, the electroluminescent device is an organic light-emitting diode OLED, and the organic light-emitting diode OLED emits light after being powered on. The electroluminescent device in each pixel circuit 100 on the display panel 10 emits light to implement image display. The voltage compensation circuit 200 compensates for a programming voltage to obtain a compensation current, the compensation current is converted into a voltage signal of a control end of a second transistor TD of the pixel circuit, so that the second transistor TD is controlled by using the voltage signal to generate a current, to supply power to the organic light-emitting diode OLED. In this way, the organic light-emitting diode OLED more stably emits light, and a light-emitting effect is better. For example, each voltage compensation circuit 200 is disposed on an outer side of the pixel circuit 100. For example, each voltage compensation circuit 200 is disposed on one side of the pixel circuit 100.

For example, as shown in FIG. 1, the display panel 10 includes a view area (AA, View Area, also referred to as a visual area) and a programming area. Each of the pixel circuits 100 is disposed in the view area, each pixel circuit in the view area is connected to a drive circuit in an array substrate row, the drive circuit in the array substrate row is connected to a drive IC, and each of the voltage compensation circuits 200 is disposed in the programming area. For example, each of the voltage compensation circuits 200 is disposed outside the view area, each of the voltage compensation circuits is connected to a clock drive circuit, and the clock drive circuit is connected to a clock drive IC. Specifically, each block diagram A in FIG. 1 is one pixel circuit 100, and each block diagram B is one voltage compensation circuit 200. In this way, the voltage compensation circuits 200 in the programming area occupy no display area of the view area.

For example, the programming voltage input end is used to receive a V_{data} signal, For example, a signal that is output by the programming current output end is an I_{data} signal, that is, a programmed current. Each voltage compensation circuit 200 is connected to a drive IC, and the drive IC provides a clock signal to the voltage compensation circuit 200, so that parts in the voltage compensation circuit 200 are conducted in different sequences, thereby programming a current.

For example, the initialization circuit 210 is used to charge two ends of the first capacitor CstU when the initialization circuit 210 is turned on or conducted, so that voltages at the two ends of the first capacitor CstU are initialized, The short-connection circuit 220 is used to establish a short connection between the control end and the first connection end of the first driving transistor TDU when the short-connection circuit 220 is turned on or conducted. The programming voltage input circuit 230 is used to connect the programming voltage input end and the second connection end of the first driving transistor TDU when the programming voltage input circuit 230 is turned on or conducted. The programming current output circuit 240 is used to connect the second connection end of the first driving transistor TDU and the programming current output end when the programming current output circuit 240 is turned on or conducted.

Specifically, as shown in FIG. 2, in a first sequence, the initialization circuit 210 is conducted, and the first voltage signal end and the second voltage signal end receive voltage signals, so that the voltages at the two ends of the first capacitor CstU are initialized. For example, the first voltage signal end is a V_{INIT} end used to receive a V_{INIT} signal, and the second voltage signal end is an ELVDD end used to receive an ELVDD signal. In a second sequence, the short-connection circuit 220 is conducted, so that a short connection is established between the control end and the first connection end of the first driving transistor TDU; the programming voltage input circuit 230 is conducted, and the programming voltage input end receives the programming voltage and inputs the programming voltage to the first driving transistor TDU. For example, the programming voltage input end is a V_{data} end used to receive a V_{data} signal, so that a voltage V_{data} that is input by the programming voltage input end to the first driving transistor TDU is compensated for. In a third sequence, the programming current output circuit 240 is turned on, the programming current output end outputs a current I_{data} that is compensated for, and the programming current output end provides the current that is compensated for to a control end that is of the pixel circuit and that controls a transistor, so that the current of the pixel circuit is compensated for with a relatively desirable current compensation effect. In addition, no dedicated current programming IC is required, thereby effectively reducing current compensation difficulty and production costs.

For example, as shown in FIG. 1, each of the pixel circuits is disposed in a plurality of rows. For example, each of the voltage compensation circuits 200 is disposed in at least one row. In other words, the display panel includes at least one row of voltage compensation circuits 200. Specifically, one row of voltage compensation circuits 200 includes a plurality of voltage compensation circuits 200, pixel circuits in a same column are connected to a programming current output end of a same voltage compensation circuit 200. The pixel circuits are disposed in R rows and C columns In other words, a quantity of rows of the pixel circuits is R and a quantity of columns of the pixel circuits is C. In this way, the programming voltage input end inputs a V_{data} signal to each voltage compensation circuits 200, and the voltage compensation circuit 200 programs the voltage V_{data} to obtain the current I_{data} that is compensated for, and inputs the current I_{data} that is compensated for to the pixel circuits in each rows.

To increase drive efficiency, in an embodiment, referring to FIG. 1, each of the voltage compensation circuits 200 is disposed in two rows. In this embodiment, the voltage compensation circuits 200 in two rows separately provide the current that is compensated for to each row of pixel circuits. In other words, the voltage compensation circuits 200 in two rows sequentially provide, in different sequences, the current that is compensated for to each row of pixel circuits. For example, the voltage compensation circuits 200 in a same row provide, in a same sequence, a current that is compensated for to the pixel circuit. In one sequence, conduction of the programming voltage input circuit 230 is controlled, so that the voltage compensation circuits 200 in a same row simultaneously work, and the voltage compensation circuits 200 in the two rows sequentially work. In this way, drive efficiency can be effectively increased, and is higher than drive efficiency generated when a single row of voltage compensation circuits 200 is used.

To make the pixel circuits in rows work more orderly, in an embodiment, referring to FIG. 1 again, each of the pixel circuits is disposed in a plurality of rows, and pixel circuits in a same row are separately connected to programming current output ends of voltage compensation circuits 200 in a same row. For example, pixel circuits in two adjacent rows are separately connected to programming current output ends of voltage compensation circuits 200 in divergent rows. In other words, pixel circuits in two adjacent rows are separately connected to voltage compensation circuits 200 in different rows. For example, pixel circuits in an odd-numbered row are connected to programming current output ends of voltage compensation circuits 200 in one row, and pixel circuits in an even-numbered row are connected to programming current output ends of voltage compensation circuits 200 in the other row. In this way, in different sequences, the pixel circuits in two adjacent rows separately obtain a current signal generated after compensation, so that the pixel circuits in each row an sequentially emit light, thereby effectively increasing light-emitting efficiency.

It should be understood that the voltage compensation circuits may be disposed in a plurality of rows. For example, the voltage compensation circuits may be disposed in three or four rows. For example, if each of the voltage compensation circuits is disposed in three rows, pixel circuits in three adjacent rows are separately connected to programming current output ends of voltage compensation circuits in divergent rows. For example, pixel circuits in a first row, a fourth row, a seventh row . . . are all connected to voltage compensation circuits in a first row. For example, pixel circuits in a second row, a fifth row, an eighth row . . . are all connected to voltage compensation circuits in a second row. For example, pixel circuits in a third row, a sixth row, a ninth row . . . are all connected to voltage compensation circuits in a third row. For example, each of the voltage compensation circuits is disposed in four rows, pixel circuits in four adjacent rows are separately connected to programming current output ends of voltage compensation circuits in divergent rows.

It should be understood that a smaller quantity of rows of voltage compensation circuits requires more sequences. For example, when there is only one row of voltage compensation circuits, to enable pixel circuits in different rows to separately obtain a current signal generated after compensation, voltage programming needs to be separately performed for the pixel circuits in the plurality of rows and a current that is compensated for needs to be provided for the pixel circuits in the plurality of rows. In this way, consequently, when receiving the current that is compensated for, the pixel circuits in two adjacent rows needs to wait for a voltage programming time, thereby leading to low light-emitting efficiency, However, a larger quantity of rows of voltage compensation circuits requires fewer sequences. In this way, light-emitting efficiency of pixel circuits in each row can be increased, but the voltage compensation circuits of the display panel occupy a relatively larger area. This does not facilitate an increase in an area of the view area, costs of the display panel are increased, and more clock signals are also required. Therefore, each of the voltage compensation circuits is disposed in two rows. In this way, a quantity of sequences is reduced and light-emitting efficiency is increased. In addition, an occupation area of the programming area is relatively small, the area of the view area is relatively large, and production costs are effectively reduced.

To control conduction and turn-off of the initialization circuit, in an embodiment, c, the initialization circuit further includes a first transistor T1U and a seventh transistor T7U, a first connection end of the first transistor T1U is connected to the first voltage signal end, a second connection end of the first transistor T1U is connected to the first end of the first capacitor CstU, the second end of the first capacitor CstU is connected to a first connection end of the seventh transistor T7U, and a second connection end of the seventh transistor T7U is connected to the second voltage signal end. A control end of the first transistor T1U is connected to a first control signal end, and a control end of the seventh transistor T7U is connected to a second control signal end.

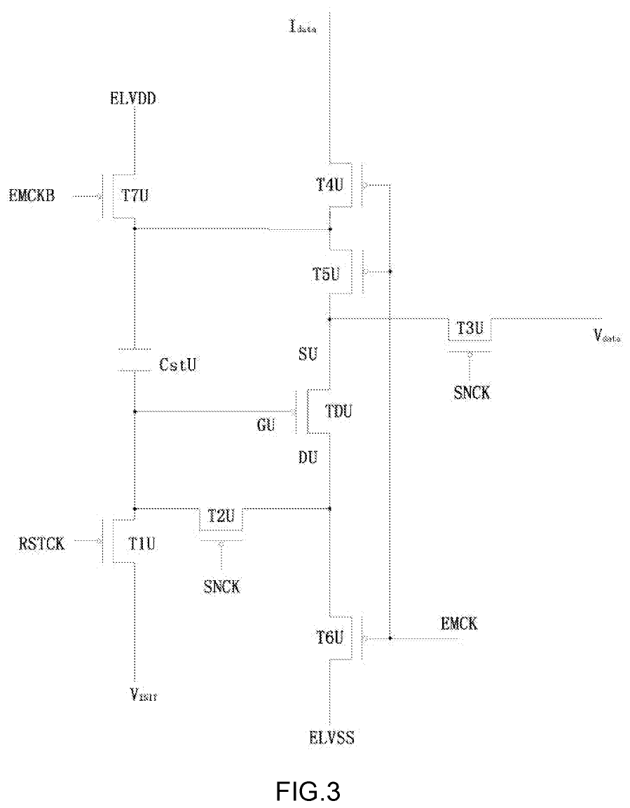

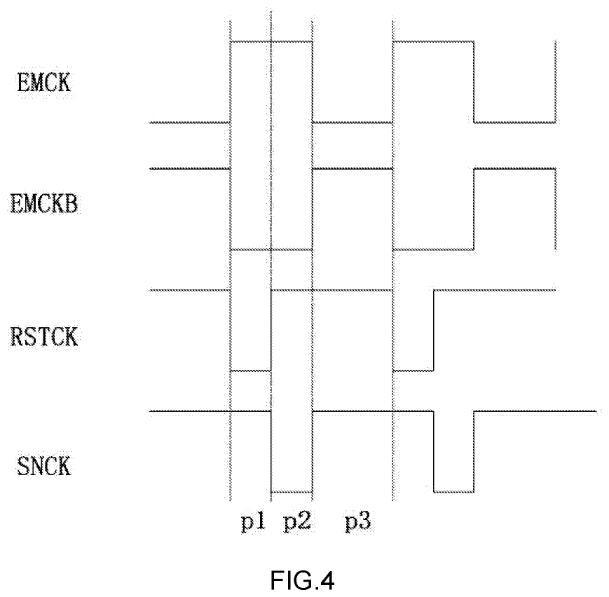

Specifically, with reference to FIG. 3 and FIG. 4, in a first sequence, a drive IC separately sends a signal to the control end of the first transistor T1U and the control end of the seventh transistor T7U, and when the first transistor T1U and the seventh transistor T7U separately receive the control signal from the first control signal end and the second control signal end, the first transistor T1U and the seventh transistor T7U are turned on. For example, the first control signal end is used to receive an RSTCK signal, the second control signal end is used to receive an EMCKB signal, and the RSTCK signal and the EMCKB signal are active low. After the first transistor T1U and the seventh transistor T7U are turned on, the initialization circuit is conducted, the first voltage signal end and the second voltage signal end separately initialize the voltages at the two ends of the first capacitor CstU, and the voltages at the two ends of the first capacitor CstU are respectively VINIT and ELVDD.

To enable a short connection to be established between the control end and the first connection end of the first driving transistor TDU, in an embodiment, as shown in FIG. 3, the short-connection circuit includes a second transistor T2U, a first connection end of the second transistor T2U is connected to the control end of the first driving transistor TDU, a second connection end of the second transistor T2U is connected to the first connection end of the first driving transistor TDU, and a control end of the second transistor T2U is connected to a third control signal end.

Specifically, with reference to FIG. 3 and FIG. 4, in a second sequence, a drive IC sends a control signal to the control end of the second transistor T2U by using the third control signal end. For example, the third control signal end is used to receive an SNCK signal After the control end of the second transistor T2U receives the low-level SNCK signal, the second transistor T2U is turned on, so that a short connection is established between the control end and the first connection end of the first driving transistor TDU.

To input, in different sequences, a programming voltage to the voltage compensation circuits in different rows, in an embodiment, as shown in FIG. 3, the programming voltage input circuit includes a third transistor T3U, a first connection end of the third transistor T3U is connected to the second connection end of the first driving transistor TDU, a second connection end of the third transistor T3U is connected to the programming voltage input end, and a control end of the third transistor T3U is connected to a third control signal end.

Specifically, with reference to FIG. 3 and FIG. 4, in a second sequence, a drive IC sends a control signal to the control end of the third transistor T3U by using the third control signal end, in other words, an SNCK signal. After the control end of the third transistor T3U receives the low-level SNCK signal, the third transistor T3U is turned on, so that the programming voltage input end is connected to the second connection end of the first driving transistor TDU, and the programming voltage input end receives the programming voltage V_{data} and inputs the programming voltage V_{data} to the first driving transistor TDU In this way, in different sequences, the voltage compensation circuits in different rows can sequentially obtain the programming voltage.

To control the current, which is compensated for, of the voltage compensation circuit to be input to the pixel circuit, in an embodiment, as shown in FIG. 3, the programming current output circuit further includes a fourth transistor T4U, a fifth transistor T5U, and a sixth transistor T6U. A first connection end of the sixth transistor T6U is connected to the third voltage signal end, a second connection end of the sixth transistor T6U is connected to the first connection end of the first driving transistor TDU, the second connection end of the first driving transistor TDU is connected to a first connection end of the fifth transistor T5U, a second connection end of the fifth transistor T5U is connected to a first connection end of the fourth transistor T4U, a second connection end of the fourth transistor T4U is connected to the programming current output end, and the programming current output end is separately connected to the pixel circuits. A control end of the fourth transistor T4U, a control end of the fifth transistor T5U, and a control end of the sixth transistor T6U are separately connected to a fourth control signal end,

Specifically, with reference to FIG. 3 and FIG. 4, the fourth control signal end is used to receive an EMCK signal, and the third voltage signal end is used to receive an ELVSS signal. In a third sequence, a drive IC sends a control signal to the control end of the fourth transistor T4U, the control end of the fifth transistor T5U, and the control end of the sixth transistor T6U by using the fourth control signal end, in other words, the EMCK signal. After the control end of the fourth transistor T4U, the control end of the fifth transistor T5U, and the control end of the sixth transistor T6U receives the low-level EMCK signal, the fourth transistor T4U, the fifth transistor T5U, and the sixth transistor T6U are turned on, so that the second connection end of the first driving transistor TDU provides the current that is compensated for to the pixel circuit by using the programming current output end and the pixel circuit. Turn-on of programming current output circuits of voltage compensation circuits in different rows are controlled in different sequences, so that pixel circuits in different rows can sequentially obtain the current that is compensated for.

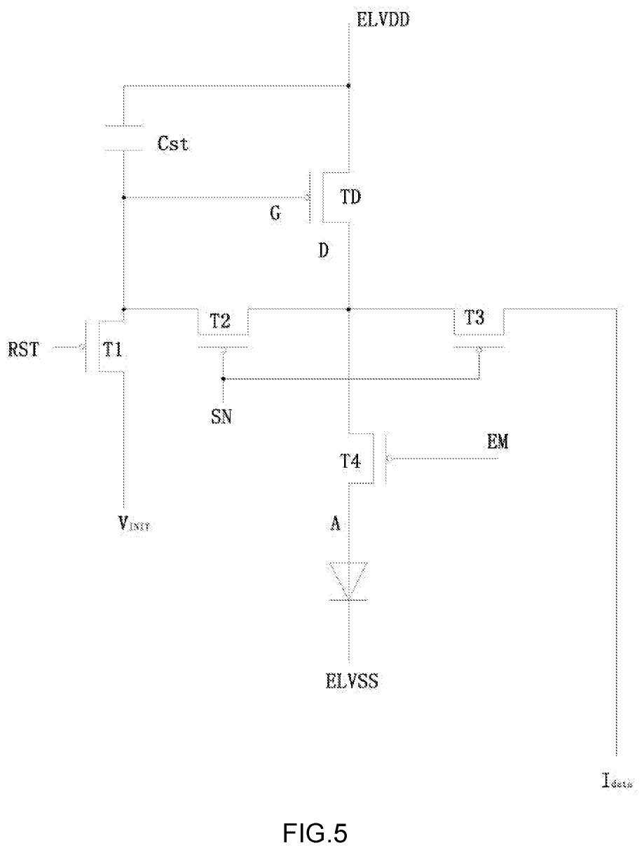

To enable each pixel circuit and a corresponding voltage compensation circuit to work in a same sequence, to enable the current that is compensated for to be input to an OLED, and to enable the OLED to emit light, in an embodiment, as shown in FIG. 5, each pixel circuit includes a first switching transistor T1, a second switching transistor T2, a third switching transistor T3, a fourth switching transistor T4, a second capacitor Cst, a second driving transistor TD, and an electroluminescent device. A first connection end of the first switching transistor T1 is connected to the first voltage signal end, a second connection end of the first switching transistor T1 is separately connected to a first end of the second capacitor Cst and a control end of the second driving transistor TD, a second end of the second capacitor Cst is connected to a second connection end of the second driving transistor TD, the second connection end of the second driving transistor TD is connected to the second voltage signal end, a first connection end of the second driving transistor TD is separately connected to a first connection end of the third switching transistor T3, a first connection end of the second switching transistor T2, and a first connection end of the fourth switching transistor T4, a second connection end of the third switching transistor T3 is connected to the programming current output end, a second connection end of the second switching transistor T2 is connected to the first end of the second capacitor Cst, a second connection end of the fourth switching transistor T4 is connected to a positive electrode of the electroluminescent device, and a negative electrode of the electroluminescent device is connected to the third voltage signal end. A control end of the first switching transistor T1 is connected to a fifth control signal end, a control end of the second switching transistor T2 and a control end of the third switching transistor T3 are connected to a sixth control signal end, and a control end of the fourth switching transistor T4 is connected to a seventh control signal end.

For example, the electroluminescent device is an organic light-emitting diode OLED. For example, the first switching transistor T1, the second switching transistor T2, the third switching transistor T3, the fourth switching transistor T4, and the second driving transistor TD are TFTs (Thin Film Transistor, thin film transistor), Control ends of each switching transistor and the second driving transistor TD are gates. First connection ends of each switching transistor and the second driving transistor TD may be sources or drains.

For example, the first switching transistor T1, the second switching transistor T2, the third switching transistor T3, the fourth switching transistor T4, and the second driving transistor TD are PMOSs (positive channel metal oxide semiconductor transistor). For another example, the first switching transistor T1 the second switching transistor T2, the third switching transistor T3, the fourth switching transistor T4, and the second driving transistor TD are NMOSs (negative channel metal oxide semiconductor transistor).

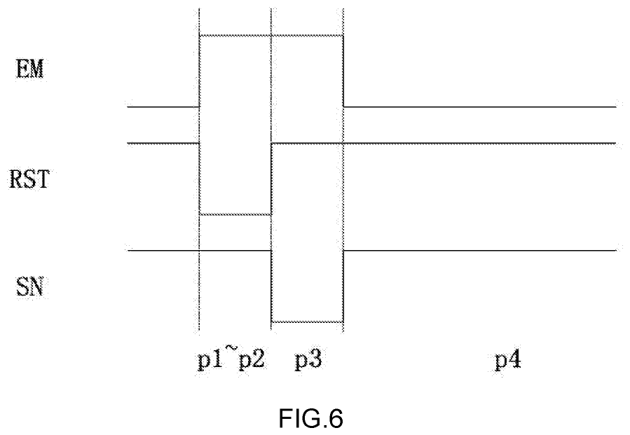

Specifically, with reference to FIG. 5 and FIG. 6, in a first sequence and a second sequence, a drive IC sends a low-level RST signal to the control end of the first switching transistor T1 by using the fifth control signal end, so that the first switching transistor T1 is turned on. However, the second switching transistor T2, the third switching transistor T3, and the fourth switching transistor T4 are turned off at this time, and a gate of the second driving transistor TD is initialized as a voltage V_{INIT}. In a third sequence, a driving IC sends a low-level SN signal to the control end of the second switching transistor T2 and the control end of the third switching transistor T3 by using the sixth control signal end, so that the second switching transistor T2 and the third switching transistor T3 are turned on. However, the first switching transistor T1 and the fourth switching transistor T4 are turned off at this time. After the second driving transistor TD stabilizes, a current flowing through the second driving transistor TD is just equal to a current I_{data} that is compensated for and that is input by the programming current output end. In this case, for the second driving transistor TD, V_{g}=V_{d}, a voltage stabilizes, and the second driving transistor TD works in a saturation area. In a fourth sequence, a drive IC sends a low-level EM signal to the control end of the fourth switching transistor T4 by using the seventh control signal end, so that the fourth switching transistor T4 is turned on. However, the first switching transistor T1, the second switching transistor T2, and the third switching transistor T3 are all turned off. Because a voltage of the second capacitor Cst stabilizes, Vg keeps consistent with that in the third sequence, and a first connection end of the second driving transistor TD is connected to a positive electrode of the OLED. However, in this case, the second driving transistor TD still works in the saturation area, in other words, the current provided by the second driving transistor TD is still I_{data}. Therefore, the current I(OLED) flowing through the OLED is equal to I(TD), and is equal to a current I_{data}=I(TDU) provided by the voltage compensation circuit in the third sequence. Therefore, the current of the OLED is compensated for. A view area uses a pixel circuit whose current is compensated for. Therefore, a circuit structure is relatively simple, and there is no need to use such a large value of a conventional voltage compensation pixel circuit for a length of the second driving transistor TD (because precision of V_{data} is considered in the conventional pixel circuit, the length of the second driving transistor TD cannot be made too small). In this way, an area of the pixel circuit in the view area may be made smaller, and a high PPI (Pixels Per Inch, pixels per inch) is more easily implemented. In addition, electron mobility of the second driving transistor in the view area can be further compensated for.

The following is a specific embodiment:

In this embodiment, a display panel is provided, as shown in FIG. 1, including: R rows of pixel circuits 100 and two rows of voltage compensation circuits 200. Pixel circuits in an odd-numbered row are connected to voltage compensation circuits in one row, and pixel circuits in an even-numbered row are connected to voltage compensation circuits in the other row.

As shown in FIG. 3, each of the voltage compensation circuits includes a first transistor T1U a second transistor T2U, a third transistor T3U, a fourth transistor T4U, a fifth transistor T5U, a sixth transistor T6U, a seventh transistor T7U, a first capacitor CstU and a first driving transistor TDU.

A first connection end of the first transistor T1U is connected to a first voltage signal end, a second connection end of the first transistor T1U is connected to a first end of the first capacitor CstU, a second end of the first capacitor CstU is connected to a first connection end of the seventh transistor T7U, and a second connection end of the seventh transistor T7U is connected to a second voltage signal end.

A control end of the first driving transistor TDU is connected to the first end of the first capacitor CstU, a first connection end of the second transistor T2U is connected to the control end of the first driving transistor TDU, a second connection end of the second transistor T2U is connected to a first connection end of the first driving transistor TDU, a second connection end of the first driving transistor TDU is connected to a first connection end of the third transistor T3U, and a second connection end of the third transistor T3U is connected to a programming voltage input end.

A first connection end of the sixth transistor T6U is connected to a third voltage signal end, a second connection end of the sixth transistor T6U is connected to the first connection end of the first driving transistor TDU, the second connection end of the first driving transistor TDU is connected to a first connection end of the fifth transistor T5U, a second connection end of the fifth transistor T5U is connected to a first connection end of the fourth transistor T4U, a second connection end of the fourth transistor T4U is connected to a programming current output end, and the programming current output end is separately connected to the pixel circuits.

A control end of the first transistor T1U is connected to a first control signal end, a control end of the seventh transistor T7U is connected to a second control signal end, a control end of the second transistor T2U and a control end of the third transistor T3U are connected to a third control signal end, and a control end of the fourth transistor T4U, a control end of the fifth transistor T5U, and a control end of the sixth transistor T6U are separately connected to a fourth control signal end.

In the foregoing embodiment, the first transistor T1U, the second transistor T2U, the third transistor T3U, the fourth transistor T4U, the fifth transistor T5U, the sixth transistor T6U, the seventh transistor T7U, and the first driving transistor TDU are TFTs (Thin Film Transistor, thin film transistor, which is referred to as transistors below). A control end of each transistor is a gate of the transistor, a first connection end of each transistor is a drain or a source of the transistor, and a second connection end may also be a drain or a source of the transistor. For example, when the first connection end is a drain, the second connection end is a source. For example, when the first connection end is a source, the second connection end is a drain. It should be noted that all first connection ends of the transistors are not sources or drains. In other words, when the first connection end of the first transistor T1U is a source, the first connection end of the second transistor T2U may be a drain. Each transistor is turned on when the control end receives a low-level signal.

For example, the first transistor T1U, the second transistor T2U, the third transistor T3U, the fourth transistor T4U, the fifth transistor T5U, the sixth transistor T6U, the seventh transistor T7U, and the first driving transistor TDU are PMOSs (positive channel metal oxide semiconductor transistor). For another example, the first transistor T1U, the second transistor T2U, the third transistor T3U, the fourth transistor T4U, the fifth transistor T5U, the sixth transistor T6U, and the seventh transistor T7U are NMOSs (negative channel metal oxide semiconductor transistor). In other words, the foregoing transistors may be PMOSs or NMOSs.

As shown in FIG. 5, each of the pixel circuits includes a first switching transistor T1, a second switching transistor T2, a third switching transistor 13, a fourth switching transistor T4, a second capacitor Cst, a second driving transistor TD, and an electroluminescent device. A first connection end of the first switching transistor T1 is connected to the first voltage signal end, a second connection end of the first switching transistor T1 is separately connected to a first end of the second capacitor Cst and a control end of the second driving transistor TD, a second end of the second capacitor Cst is connected to a second connection end of the second driving transistor TD, the second connection end of the second driving transistor TD is connected to the second voltage signal end, a first connection end of the second driving transistor TD is separately connected to a first connection end of the third switching transistor T3, a first connection end of the second switching transistor T2, and a first connection end of the fourth switching transistor T4, a second connection end of the third switching transistor T3 is connected to the programming current output end, a second connection end of the second switching transistor T2 is connected to the first end of the second capacitor Cst, a second connection end of the fourth switching transistor T4 is connected to a positive electrode of the electroluminescent device, and a negative electrode of the electroluminescent device is connected to the third voltage signal end. A control end of the first switching transistor T1 is connected to a fifth control signal end, a control end of the second switching transistor T2 and a control end of the third switching transistor T3 are connected to a sixth control signal end, and a control end of the fourth switching transistor T4 is connected to a seventh control signal end.

In this embodiment, with reference to FIG. 3 to FIG. 6, a signal at the first control signal end is RSTCK, a signal at the second control signal end is EMCKB, a signal at the third control signal end is SLACK, a signal at the fourth control signal end is EMCK, a signal at the fifth control signal end is RST, a signal at the sixth control signal end is SN, a signal at the seventh control signal end is EM, and when the control end of each transistor or the control end of each switching transistor receives a low-level signal, the transistor or the switching transistor is turned on. The first sequence is a period p1, the second sequence is a period p2, the third sequence is a period p3, and the fourth sequence is a period p4. The control end of the first driving transistor is a Gu electrode (a gate), the first connection end is a DU electrode (a drain), the second connection end is an SU electrode (a source), the control end of the second driving transistor is a G electrode (a gate), the first connection end is a D electrode (a drain), the second connection end is an S electrode (a source), voltage signal of the first voltage signal end is a VINIT, a voltage signal of the second voltage signal end is ELVDD, and a voltage signal of the third voltage signal end is ELVSS.

For the voltage compensation circuit, descriptions are provided with reference to FIG. 3 and FIG. 4:

In the period p1, RSTCK and EMCKB are at a low level, T1U and T7U are turned on, and the remaining switching TFTs are turned off. After the first capacitor CstU is charged, voltages at two ends are separately ELVDD and V_{INIT}.

In the period p2, the SNCK and the EMCKB are at a low level, T2U, T3U, T7U are turned on, and the remaining switching TFTs are turned off, After V_{data} from an IC passes through a TDU for which a G electrode and a D electrode are in a short connection, a charging voltage of the G electrode of the first driving transistor TDU is V_{data}+V_{thU}. V_{thU} is a threshold voltage of the first driving transistor TDU, and a threshold voltage of the P-channel TFT is usually negative.

In the period p3, EMCK is at a low level, T4U, T5U, and T6U are turned on, and the remaining switching TFTs are turned off. A voltage V_{gsU} between the gate and the source of the first driving transistor TDU remains the same as that in the period p2, in other words, V_{gsU}=V_{data}+V_{thU}−ELVDD. In this case, the programming current output end is connected to a pixel circuit in a column corresponding to a first row in the view area, the programming current output end inputs the current I_{data} to the pixel circuit, and a relatively high voltage is set for the programming current output end. In this case, a current passing through the first driving transistor TDU is:

$$I ( TDU ) = \frac{1}{2} μ {C}_{OX} \frac{W}{L} {( {V}_{gaU} - {V}_{thU} )}^{2} = \frac{1}{2} μ {C}_{OX} \frac{W}{L} {( {V}_{DAT} - ELVDD )}^{2} ,$$

μ is electron mobility of a channel of TDU, Cox is a channel capacitance in a unit area of TDU, W is a channel width of TDU, and L is a channel length of TDU.

I(TDU) is a current that is compensated for, and obviously, I_{data}=I(TDU). In other words, I_{data} is a current that is compensated for.

For the pixel circuit, with reference to FIG. 5 and FIG. 6, in periods p1 and p2, the RST is at a low level, T1 is turned on, the remaining switching transistors TFTs are turned off, and the G electrode of the second driving transistor TD is initialized as a V_{INIT}.

In the period p3, SN is at a low level, T2 and T3 are conducted, the remaining switching TFTs are turned off, and a current flowing through the TD after stabilization is exactly equal to I_{data}. In this case, V_{g}=V_{d}, the voltage is stable, and working is performed in a saturation area.

In the period p4, EM is at a low level, T4 is conducted, and the remaining switching TFTs are turned off. Because a voltage for capacitance is stable, V_{g} remains consistent with that in the period p3, and the d electrode of TD is connected to a positive electrode of the OLED. However, in this case, working is still performed in the saturation area. In other words, the current provided by the TD is still I_{data}. Therefore, I(OLED) is equal to I(TD), and is equal to the current I_{data}=I(TDU) provided by the voltage compensation circuit in the period p3.

Because a current compensation pixel circuit is used in a view area, a circuit structure is relatively simple. Because precision of T_{data} is considered in a conventional pixel circuit, a length of a driving transistor cannot be made too small, and there is no need to use such a large value of the conventional voltage compensation pixel circuit for a length of the second driving transistor TD, an area of the pixel circuit in the view area may be made smaller, and a high PPI is more easily implemented. In addition, electron mobility of the DTFT in the AA can be further compensated for.

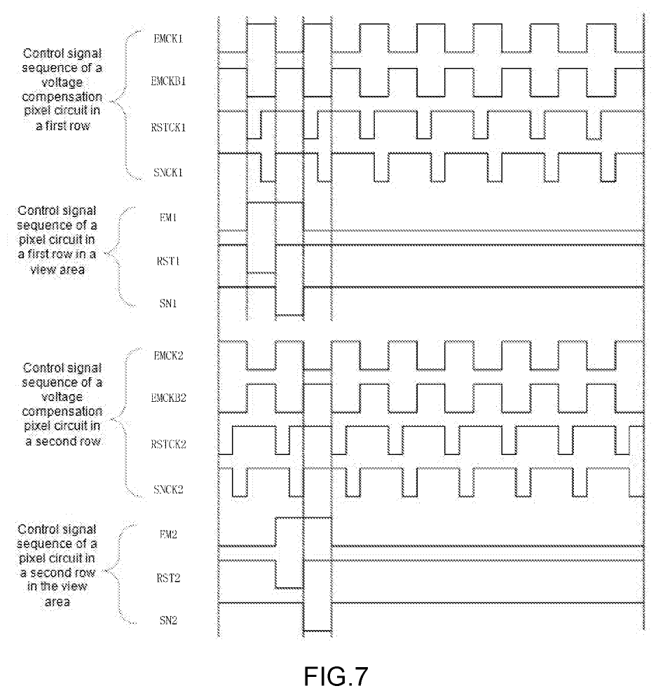

In this embodiment, control signal sequences of voltage compensation pixel circuits in a first row and in a second row and control signal sequences of pixel circuits in a first row and in a second row in the view area are shown in FIG. 7, and control signal sequences of pixel circuits in a third row, fourth row, fifth row, sixth row . . . are obtained by analogy.

In an embodiment, a display apparatus is provided, including the display panel in any one of the foregoing embodiments, The display panel further includes two drive ICs, and the two drive ICs are respectively a first IC and a second IC. The first IC is used to provide a second voltage signal ELVDD and a third voltage signal ELVSS. That is, the first IC is used to provide a second voltage signal end with a second voltage signal ELVDD and a third voltage signal end with a third voltage signal ELVSS. The second IC is used to provide a first voltage signal V_{INIT}, a programming voltage signal V_{data}, a first control signal RSTCK, a second control signal EMCKB, a third control signal SNCK, a fourth control signal EMCK, a fifth control signal RST, a sixth control signal SN, and a seventh control signal EM. That is, the second IC is used to provide the first voltage signal end with a first voltage signal V_{INIT}, a programming voltage signal end with a programming voltage signal V_{data}, a first control signal end with a first control signal RSTCK, a second control signal end with a second control signal EMCKB, a third control signal end with a third control signal SNCK, a fourth control signal end with a fourth control signal EMCK, a fifth control signal end with a fifth control signal RST, a sixth control signal end with a sixth control signal SN, and a seventh control signal end with a seventh control signal EM.

For example, a second voltage signal pin and a third voltage signal pin are disposed on the first IC, the second voltage signal pin is connected to the second voltage signal end, and the third voltage signal pin is connected to the third voltage signal end. For example, a first voltage signal pin, a programming voltage signal pin, a first control signal pin, a second control signal pin, a third control signal pin, a fourth control signal pin, a fifth control signal pin, a sixth control signal pin, and a seventh control signal pin are disposed on the second IC. Specifically, the first voltage signal pin is connected to the first voltage signal end, the programming voltage signal pin is connected to the programming voltage signal end, the first control signal pin is connected to the first control signal end, the second control signal pin is connected to the second control signal end, the third control signal pin is connected to the third control signal end, the fourth control signal pin is connected to the fourth control signal end, the fifth control signal pin is connected to the fifth control signal end, the sixth control signal pin is connected to the sixth control signal end, and the seventh control signal pin is connected to the seventh control signal end. For example, the second IC is used to provide a clock signal.

The technical features of the foregoing embodiments can be arbitrarily combined. In order to simplify the descriptions, all possible combinations of the technical features in the above embodiments have not been described. However, as long as there is no contradiction in the combinations of these technical features, it should be considered as the scope described in this specification.

The foregoing embodiments only express several implementations of the present invention Descriptions of the foregoing embodiments are relatively specific and detailed, but cannot be understood as limiting the scope of the patent for the present invention. It should be noted that, for those of ordinary skill in the art, without departing from the concept of the present invention, modifications and improvements can be made, and all belong to the protection scope of the present invention.

Therefore, the protection scope of he patent for the present invention shall be subject to the appended claims.

What is claimed is:

1. A display panel, comprising a plurality of pixel circuits and a plurality of voltage compensation circuits;
each of the voltage compensation circuits comprises an initialization circuit, a short-connection circuit, a programming voltage input circuit, and a programming current output circuit;
the initialization circuit comprises a first capacitor, a first end of the first capacitor is connected to a first voltage signal end, and a second end of the first capacitor is connected to a second voltage signal end;
the programming current output circuit comprises a first driving transistor, a control end of the first driving transistor is connected to the first end of the first capacitor, the control end of the first driving transistor is connected to a first connection end of the first driving transistor by using a short-connection circuit, and a second connection end of the first driving transistor is connected to the programming voltage input circuit;
the programming voltage input circuit is connected to a programming voltage input end, the first connection end of the first driving transistor is further connected to a third voltage signal end, and the second connection end of the first driving transistor is further connected to a programming current output end; and
the programming current output end is separately connected to the plurality of pixel circuits.

2. The display panel according to claim 1, wherein the initialization circuit further comprises a first transistor and a seventh transistor, a first connection end of the first transistor is connected to the first voltage signal end, a second connection end of the first transistor is connected to the first end of the first capacitor, the second end of the first capacitor is connected to a first connection end of the seventh transistor, and a second connection end of the seventh transistor is connected to the second voltage signal end; and
a control end of the first transistor is connected to a first control signal end, and a control end of the seventh transistor is connected to a second control signal end.

3. The display panel according to claim 1, wherein the short-connection circuit comprises a second transistor, a first connection end of the second transistor is connected to the control end of the first driving transistor, a second connection end of the second transistor is connected to the first connection end of the first driving transistor, and a control end of the second transistor is connected to a third control signal end.

4. The display panel according to claim 1, wherein the programming voltage input circuit comprises a third transistor, a first connection end of the third transistor is connected to the second connection end of the first driving transistor, a second connection end of the third transistor is connected to the programming voltage input end, and a control end of the third transistor is connected to a third control signal end.

5. The display panel according to claim 1, wherein the programming current output circuit further comprises a fourth transistor, a fifth transistor, and a sixth transistor;
a first connection end of the sixth transistor is connected to the third voltage signal end, a second connection end of the sixth transistor is connected to the first connection end of the first driving transistor, the second connection end of the first driving transistor is connected to a first connection end of the fifth transistor, a second connection end of the fifth transistor is connected to a first connection end of the fourth transistor, a second connection end of the fourth transistor is connected to the programming current output end, and the programming current output end is separately connected to the pixel circuits; and
a control end of the fourth transistor, a control end of the fifth transistor, and a control end of the sixth transistor are separately connected to a fourth control signal end.

6. The display panel according to claim 1, wherein each of he voltage compensation circuits is disposed in two rows.

7. The display panel according to claim 6, wherein each of the pixel circuits is disposed in a plurality of rows, and pixel circuits in a same row are separately connected to programming current output ends of voltage compensation circuits in a same row.

8. The display panel according to claim 6, wherein pixel circuits in two adjacent rows are separately connected to programming current output ends of voltage compensation circuits in divergent rows

9. The display panel according to claim 8, wherein pixel circuits in an odd-numbered row are connected to programming current output ends of voltage compensation circuits in one row, and pixel circuits in an even-numbered row are connected to programming current output ends of voltage compensation circuits in the other row.

10. The display panel according to claim 1, wherein each of the pixel circuits comprises a first switching transistor, a second switching transistor, a third switching transistor, a fourth switching transistor, a second capacitor, a second driving transistor, and an electroluminescent device;
a first connection end of the first switching transistor is connected to the first voltage signal end, a second connection end of the first switching transistor is separately connected to a first end of the second capacitor and a control end of he second driving transistor, a second end of the second capacitor is connected to a second connection end of the second driving transistor, the second connection end of the second driving transistor is connected to the second voltage signal end, a first connection end of the second driving transistor is separately connected to a first connection end of the third switching transistor, a first connection end of the second switching transistor, and a first connection end of the fourth switching transistor, a second connection end of the third switching transistor is connected to the programming current output end, a second connection end of the second switching transistor is connected to the first end of the second capacitor, a second connection end of the fourth switching transistor is connected to a positive electrode of the electroluminescent device, and a negative electrode of the electroluminescent device is connected to the third voltage signal end; and
a control end of the first switching transistor is connected to a fifth control signal end, a control end of the second switching transistor and a control end of the third switching transistor are connected to a sixth control signal end, and a control end of the fourth switching transistor is connected to a seventh control signal end.

11. A display apparatus, comprising a display panel, wherein the display panel comprises a plurality of pixel circuits and a plurality of voltage compensation circuits;
each of the voltage compensation circuits comprises an initialization circuit, a short-connection circuit, a programming voltage input circuit, and a programming current output circuit;
the initialization circuit comprises a first capacitor, a first end of the first capacitor is connected to a first voltage signal end, and a second end of the first capacitor is connected to a second voltage signal end;
the programming current output circuit comprises a first driving transistor, a control end of the first driving transistor is connected to the first end of the first capacitor, the control end of the first driving transistor is connected to a first connection end of the first driving transistor by using a short-connection circuit, and a second connection end of the first driving transistor is connected to the programming voltage input circuit;
the programming voltage input circuit is connected to a programming voltage input end, the first connection end of the first driving transistor is further connected to a third voltage signal end, and the second connection end of the first driving transistor is further connected to a programming current output end; and
the programming current output end is separately connected to the plurality of pixel circuits,

12. The display apparatus according to claim 11, wherein the initialization circuit further comprises a first transistor and a seventh transistor, a first connection end of the first transistor is connected to the first voltage signal end, a second connection end of the first transistor is connected to the first end of the first capacitor, the second end of the first capacitor is connected to a first connection end of the seventh transistor, and a second connection end of the seventh transistor is connected to the second voltage signal end; and
a control end of the first transistor is connected to a first control signal end, and a control end of the seventh transistor is connected to a second control signal end.

13. The display apparatus according to claim 11, wherein the short-connection circuit comprises a second transistor, a first connection end of the second transistor is connected to the control end of the first driving transistor, a second connection end of the second transistor is connected to the first connection end of the first driving transistor, and a control end of the second transistor is connected to a third control signal end.

14. The display apparatus according to claim 11, wherein the programming voltage input circuit comprises a third transistor, a first connection end of the third transistor is connected to the second connection end of the first driving transistor, a second connection end of the third transistor is connected to the programming voltage input end, and a control end of the third transistor is connected to a third control signal end.

15. The display apparatus according to claim 11, wherein the programming current output circuit further comprises a fourth transistor, a fifth transistor, and a sixth transistor;
a first connection end of the sixth transistor is connected to the third voltage signal end, a second connection end of the sixth transistor is connected to the first connection end of the first driving transistor, the second connection end of the first driving transistor is connected to a first connection end of the fifth transistor, a second connection end of the fifth transistor is connected to a first connection end of the fourth transistor, a second connection end of the fourth transistor is connected to the programming current output end, and the programming current output end is separately connected to the pixel circuits; and
a control end of the fourth transistor, a control end of the fifth transistor, and a control end of the sixth transistor are separately connected to a fourth control signal end.

16. The display apparatus according to claim 11, wherein each of he voltage compensation circuits is disposed in two rows.

17. The display apparatus according to claim 16, wherein each of the pixel circuits is disposed in a plurality of rows, and pixel circuits in a same row are separately connected to programming current output ends of voltage compensation circuits in a same row.

18. The display apparatus according to claim 16, wherein pixel circuits in two adjacent rows are separately connected to programming current output ends of voltage compensation circuits in divergent rows.

19. The display apparatus according to claim 18, wherein pixel circuits in an odd-numbered row are connected to programming current output ends of voltage compensation circuits in one row, and pixel circuits in an even-numbered row are connected to programming current output ends of voltage compensation circuits in the other row.

20. The display apparatus according to claim 11, wherein each of the pixel circuits comprises a first switching transistor, a second switching transistor, a third switching transistor, a fourth switching transistor, a second capacitor, a second driving transistor, and an electroluminescent device;
a first connection end of the first switching transistor is connected to the first voltage signal end, a second connection end of the first switching transistor is separately connected to a first end of the second capacitor and a control end of the second driving transistor, a second end of the second capacitor is connected to a second connection end of the second driving transistor, the second connection end of the second driving transistor is connected to the second voltage signal end, a first connection end of the second driving transistor is separately connected to a first connection end of the third switching transistor, a first connection end of the second switching transistor, and a first connection end of the fourth switching transistor, a second connection end of the third switching transistor is connected to the programming current output end, a second connection end of the second switching transistor is connected to the first end of the second capacitor, a second connection end of the fourth switching transistor s connected to a positive electrode of the electroluminescent device, and a negative electrode of the electroluminescent device is connected to the third voltage signal end; and
a control end of the first switching transistor is connected to a fifth control signal end, a control end of the second switching transistor and a control end of the third switching transistor are connected to a sixth control signal end, and a control end of the fourth switching transistor is connected to a seventh control signal end.
